(19) United States
(12) Patent Application Publication
(10) Pub. No.: US 2020/0128069 A1
(43) Pub. Date: Apr. 23, 2020

(54) CLOUD BLUETOOTH DEVICE MANAGEMENT SYSTEM

(71) Applicant: MING-TSUNG CHEN, Taipei City (TW)

(72) Inventors: MING-TSUNG CHEN, Taipei City (TW); SZU-MEI SUN, Taoyuan City (TW)

(21) Appl. No.: 16/166,401

(22) Filed: Oct. 22, 2018

(51) Int. Cl. H04L 29/08; H04L 12/24; H04W 88/16; H04W 76/11; H04W 4/80

(52) U.S. Cl. CPC H04L 67/1044; H04L 41/0893; H04W 4/80; H04W 76/11; H04W 88/16

(57) ABSTRACT

A Cloud Bluetooth device management system includes a server, a plurality of Bluetooth devices, and at least one gateway device. Each Bluetooth device includes a unique identification code. The Bluetooth devices communicates with the at least one gateway device. The gateway device communicates with the server. The identification codes of the Bluetooth devices are transmitted to the server through the gateway device. The server records the identification codes of the Bluetooth devices. A control device transmits a control command to one Bluetooth device according to a selected identification code of the Bluetooth devices recorded in the server, such that the Bluetooth device corresponding to the selected identification code executes an action corresponding to the control command.

### FIELD OF THE DISCLOSURE

The present disclosure relates to a Cloud Bluetooth device management system, and more particularly to a Cloud Bluetooth device management system.

### BACKGROUND OF THE DISCLOSURE

With the recent release of the Bluetooth 5.0 specification, Bluetooth devices using the Bluetooth 5.0 can transmit messages to each other through a MESH network. However, since the data format of the Bluetooth device is in a HEX STRING format, when the data of the Bluetooth device is uploaded to the server through the gateway device, it is not easy to perform effective data management. In addition, the server cannot effectively communicate with the Bluetooth device.

Therefore, providing a Cloud Bluetooth device management system that allows the Bluetooth device and the server to communicate with each other is an important subject in relevant industries.

### SUMMARY OF THE DISCLOSURE

In response to the above-referenced technical inadequacies, the present disclosure provides a Cloud Bluetooth device management system. The Cloud Bluetooth device management system includes a server, a plurality of Bluetooth devices, and at least one gateway device. Each Bluetooth device includes a unique identification code. The Bluetooth devices communicates with the at least one gateway device. The gateway device communicates with the server. The identification codes of the Bluetooth devices are transmitted to the server through the gateway device. The server records the identification codes of the Bluetooth devices. A control device transmits a control command to one Bluetooth device according to a selected identification code of the Bluetooth devices recorded in the server, such that the Bluetooth device corresponding to the selected identification code executes an action corresponding to the control command.

In response to the above-referenced technical inadequacies, the present disclosure provides a Cloud Bluetooth device management system. The Cloud Bluetooth device management system includes a Bluetooth device management device communicating with a control device, a first Bluetooth device including a first identification code, and a second Bluetooth device, including a second identification code. The first Bluetooth device and the second Bluetooth device communicate with the server. The first identification code and the second identification code are transmitted to the Bluetooth device management device. The Bluetooth device management device records the first identification code and the second identification code. The control device transmits a control command to the first Bluetooth device or the second Bluetooth device according to the first identification code or the second identification code, such that the first Bluetooth device or the second Bluetooth device executes an action corresponding to the control command.

According to the above, the present disclosure uses the identification codes of the Bluetooth devices, the recognition and determination of the server to address the plurality of the Bluetooth devices, such that the control device or the Bluetooth device can effectively communicate with other Bluetooth device through the server.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the detailed description and the accompanying drawings, in which:

FIG. 1 is a schematic diagram of a Cloud Bluetooth device management system according to an embodiment of the present disclosure.

FIG. 2 is a schematic diagram of a control device controlling a Bluetooth device through the Cloud Bluetooth device management system according to the embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

### First Embodiment

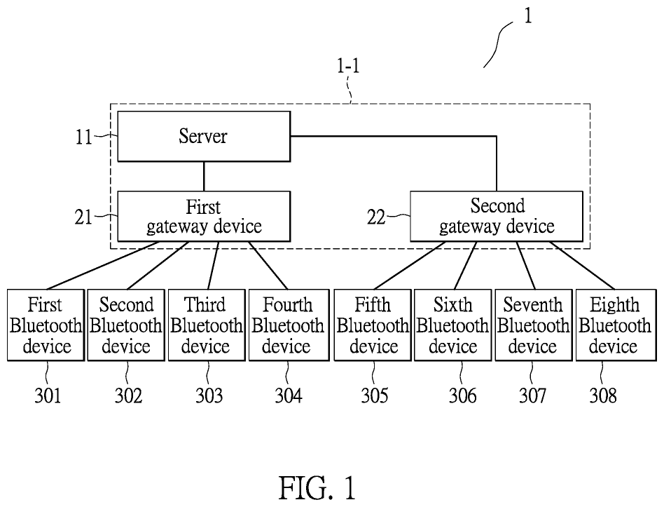

Referring to FIG. 1, FIG. 1 is a schematic diagram of a Cloud Bluetooth device management system according to an embodiment of the present disclosure.

In the embodiment, a Cloud Bluetooth device management system 1 includes a Bluetooth device management device 1-1, and a plurality of Bluetooth devices. The Bluetooth device management device 1-1 includes a server 11, a first gateway device 21, and a second gateway device 22.

In the embodiment, the Cloud Bluetooth device management system includes eight Bluetooth devices, which are a first Bluetooth device 301, a second Bluetooth device 302, a third Bluetooth device 303, a fourth Bluetooth device 304, a fifth

Bluetooth device 305, a sixth Bluetooth device 306, a seventh Bluetooth device 307, and an eighth Bluetooth device 308.

In the embodiment, the first Bluetooth device 301, the second Bluetooth device 302, the third Bluetooth device 303, the fourth Bluetooth device 304, the fifth Bluetooth device 305, the sixth Bluetooth device 306, the seventh Bluetooth device 307, and the eighth Bluetooth device 308 communicate with the first gateway device 21 and the second gateway device 22 by a first communication protocol. The first gateway device 21 and the second gateway device 22 communicate with the server 11 by a wired communication manner or a wireless communication manner, which is not limited in the present disclosure.

In the embodiment, the first wireless communication protocol includes a WIFi protocol, a LoRa protocol, a Sigfox protocol, a 4G protocol, and a 5G protocol, which is designed based on the actual requirement, and is not limited in the present disclosure. In the embodiment, the first Bluetooth device 301, the second Bluetooth device 302, the third Bluetooth device 303, the fourth Bluetooth device 304, the fifth Bluetooth device 305, the sixth Bluetooth device 306, the seventh Bluetooth device 307, and the eighth Bluetooth device 308 communicate with the first gateway device 21 and the second gateway device 22 by a Bluetooth protocol.

The second wireless communication protocol includes a WiFi protocol, a LoRa protocol, a Sigfox protocol, a 4G protocol, and a 5G protocol, which is designed based on the actual requirement, and is not limited in the present disclosure.

In the embodiment, the first Bluetooth device 301, the second Bluetooth device 302, the third Bluetooth device 303, and the fourth Bluetooth device 304 are connected to the first gateway device 21 by the first wireless communication protocol. In other words, the first Bluetooth device 301, the second Bluetooth device 302, the third Bluetooth device 303, the fourth Bluetooth device 304 are capable of transmitting data to the first gateway device 21 by the Bluetooth protocol.

The fifth Bluetooth device 305, the sixth Bluetooth device 306, the third Bluetooth device 307, and the fourth Bluetooth device 308 are connected to the second gateway device 22 by the first wireless communication protocol. In other words, the fifth Bluetooth device 305, the sixth Bluetooth device 306, the third Bluetooth device 307, and the fourth Bluetooth device 308 are capable of transmitting data to the second gateway device 22 by the Bluetooth protocol.

The first Bluetooth device 301, the second Bluetooth device 302, the third Bluetooth device 303, the fourth Bluetooth device 304, the fifth Bluetooth device 305, the sixth Bluetooth device 306, the seventh Bluetooth device 307, and the eighth Bluetooth device 308 respectively includes an unique identification code. In other words, the first Bluetooth device 301 includes a first identification code. The second Bluetooth device 302 includes a second identification code. The third Bluetooth device 303 includes a third identification code. The fourth Bluetooth device 304 includes a fourth identification code. The second Bluetooth device 305 includes a fifth identification code. The sixth Bluetooth device 306 includes a sixth identification code. The seventh Bluetooth device 307 includes a seventh identification code. The eighth Bluetooth device 308 includes an eighth identification code.

In the embodiment, the identification codes of the Bluetooth devices 301-308 are respectively transmitted to the server 11 by the first gateway device 21 or the second gateway device 22.

The server 11 records the first identification code of the first Bluetooth device 301, the second identification code of the second Bluetooth device 302, the third identification code of the third Bluetooth device 303, the fourth identification code of the fourth Bluetooth device 304, the fifth identification code of the fifth Bluetooth device 305, the sixth identification code of the sixth Bluetooth device 306, the seventh identification code of the seventh Bluetooth device 307, and the eighth identification code of the eighth Bluetooth device 308.

In addition, the first Bluetooth device 301, the second Bluetooth device 302, the third Bluetooth device 303, the fourth Bluetooth device 304, the fifth Bluetooth device 305, the sixth Bluetooth device 306, the seventh Bluetooth device 307, and the eighth Bluetooth device 308 are capable of transmitting data in a first data format.

Furthermore, when the first Bluetooth device 301, the second Bluetooth device 302, the third Bluetooth device 303, the fourth Bluetooth device 304, the fifth Bluetooth device 305, the sixth Bluetooth device 306, the seventh Bluetooth device 307, and the eighth Bluetooth device 308 transmit the data to the server 11 in the first data format by the first gateway device 21 or the second gateway device 22, the data of the first data format transmitted by the first Bluetooth device 301, the second Bluetooth device 302, the third Bluetooth device 303, the fourth Bluetooth device 304, the fifth Bluetooth device 305, the sixth Bluetooth device 306, the seventh Bluetooth device 307, and the eighth Bluetooth device 308 are converted into the data of a second data format. The data of the first Bluetooth device 301, the second Bluetooth device 302, the third Bluetooth device 303, the fourth Bluetooth device 304, the fifth Bluetooth device 305, the sixth Bluetooth device 306, the seventh Bluetooth device 307, and the eighth Bluetooth device 308 are recorded and classified by the first identification code, the second identification code, the third identification code, the fourth identification code, the fifth identification code, the sixth identification code, the seventh identification code, and the eighth identification code.

In the embodiment, the first identification code, the second identification code, the third identification code, the fourth identification code, the fifth identification code, the sixth identification code, the seventh identification code, and the eighth identification code are respectively a media access control address (MAC address) of the first Bluetooth device 301, the second Bluetooth device 302, the third Bluetooth device 303, the fourth Bluetooth device 304, the fifth Bluetooth device 305, the sixth Bluetooth device 306, the seventh Bluetooth device 307, and the eighth Bluetooth device 308. In other embodiments, the first identification code, the second identification code, the third identification code, the fourth identification code, the fifth identification code, the sixth identification code, the seventh identification code, and the eighth identification code can be the unique code of each Bluetooth device, but is not limited in the present disclosure.

### Second Embodiment

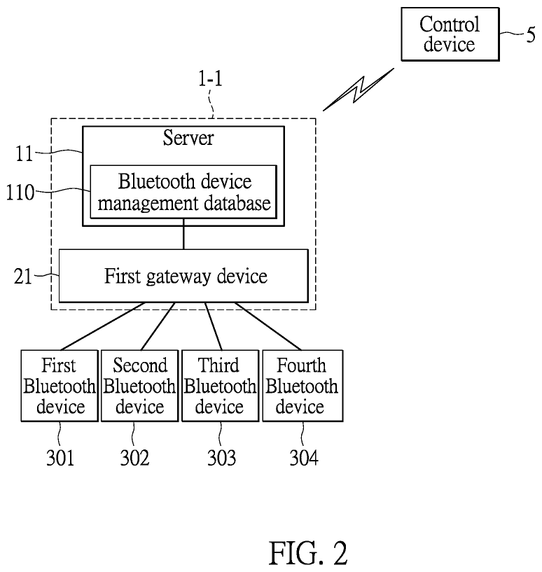

Referring to FIG. 2, FIG. 2 is a schematic diagram that a control device controls a Bluetooth device through the Cloud Bluetooth device management system according to the embodiment of the present disclosure.

In the embodiment, a control device 5 is connected to the server 11 of the Bluetooth device management device 1-1 by a wired communication manner or a third wireless communication protocol. The third communication protocol includes a WiFi protocol, a LoRa protocol, a Sigfox protocol, a 4G protocol, and a 5G protocol, which is designed based on the actual requirement, and is not limited in the present disclosure.

In the embodiment, the control device 5 is capable of obtaining the identification code of each Bluetooth device, for example, the first identification code of the first Bluetooth device 301. The control device 5 is capable of transmitting a control command to the first Bluetooth device 301 according to the first identification code for making the first Bluetooth device 301 corresponding to the first identification code to execute an action corresponding to the control command.

In other words, the control device 5 transmits a control signal including the control command and the first identification code to the server 11. The server 11 compares the first identification code with the identification codes stored in the Bluetooth device management database 110, and transmits the first identification code to the first Bluetooth device 301 by the first gateway device 21 for making the first Bluetooth device corresponding to the first identification code execute the action corresponding to the control command of the control device 5. In the present disclosure, the action is not limited.

Referring to FIG. 1, the initiator of the control command can be one of the first Bluetooth device 301, the second Bluetooth device 302, the third Bluetooth device 303, the fourth Bluetooth device 304, the fifth Bluetooth device 305, the sixth Bluetooth device 306, the seventh Bluetooth device 307, and the eighth Bluetooth device 308 connected to the first gateway device 21 or the second gateway device 22.

In other words, when one of the first Bluetooth device 301, the second Bluetooth device 302, the third Bluetooth device 303, the fourth Bluetooth device 304, the fifth Bluetooth device 305, the sixth Bluetooth device 306, the seventh Bluetooth device 307, and the eighth Bluetooth device 308 needs to transmit a control command to another Bluetooth device, one of the first Bluetooth device 301, the second Bluetooth device 302, the third Bluetooth device 303, the fourth Bluetooth device 304, the fifth Bluetooth device 305, the sixth Bluetooth device 306, the seventh Bluetooth device 307, and the eighth Bluetooth device 308 is capable of transmitting the control command and the identification code corresponding to the target Bluetooth device to the server 11 through the gateway device 21 or the gateway device 22. The server 11 compares the identification codes of the target Bluetooth device with the identification codes of the Bluetooth device management database 110 for determining which of the Bluetooth devices the control command is transmitted to. When the target Bluetooth device is determined, the server 11 transmits the control command to the target Bluetooth device, such that the target Bluetooth device can execute the action corresponding to the control command.

For example, when the first Bluetooth device 301 needs to transmit the control command to the fourth Bluetooth device 304 and the eighth Bluetooth device 308. The first Bluetooth device 301 provides the control command, the fourth identification code of the fourth Bluetooth device 304, and the eighth identification code of the eighth Bluetooth device 308 to the server 11 through the first gateway 21. When the server 11 determines that the control command is transmitted to the fourth Bluetooth device 304 and the eighth Bluetooth device 308, the server 11 respectively transmits the control command to the fourth Bluetooth device 304 and the eighth Bluetooth device 308 by the first gateway device 21 and the second gateway 22, so that the fourth Bluetooth device 304 and the eighth Bluetooth device 308 execute the action corresponding to the control command.

In the embodiment, the numbers of the gateway device and the Bluetooth device can be designed to meet actual requirements, and are not limited in the present disclosure.

According to the above, the present disclosure uses the identification codes of the Bluetooth devices, and the recognition and determination of the server for location addressing of the plurality of the Bluetooth devices, such that the control device or the Bluetooth device can effectively communicate with other Bluetooth device through the server.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A Cloud Bluetooth device management system comprising:
a server;
a plurality of Bluetooth devices, each Bluetooth device including a unique identification code; and
at least one gateway device, the Bluetooth devices communicating with the at least one gateway device, the gateway device communicating with the server, the identification codes of the Bluetooth devices transmitted to the server through the gateway device, the server recording the identification codes of the Bluetooth devices;
wherein a control device transmits a control command to one Bluetooth device according to a selected identification code of the Bluetooth devices recorded in the server, such that the Bluetooth device corresponding to the selected identification code executes an action corresponding to the control command.

2. The Cloud Bluetooth device management system of claim 1, wherein the identification code is a media access control address code of each Bluetooth device.

3. The Cloud Bluetooth device management system of claim 1, wherein the identification codes of the Bluetooth devices are stored in a Bluetooth device management database of the server.

4. A Cloud Bluetooth device management system comprising:
a Bluetooth device management device communicating with a control device;
a first Bluetooth device, including a first identification code; and
a second Bluetooth device, including a second identification code;
wherein the first Bluetooth device and the second Bluetooth device communicate with the server, the first identification code and the second identification code are transmitted to the Bluetooth device management device, the Bluetooth device management device records the first identification code and the second identification code;
wherein the control device transmits a control command to the first Bluetooth device or the second Bluetooth device according to the first identification code or the second identification code, such that the first Bluetooth device or the second Bluetooth device executes an action corresponding to the control command.

5. The Cloud Bluetooth device management system of claim 4, wherein the first Bluetooth-device management device includes:
a server; and
a first gateway device;
wherein the first Bluetooth device and the second Bluetooth device communicates with the first gateway device, the first gateway device communicates with the server, the first identification code and the second identification code are transmitted to the server through the first gateway device, the server records the first identification code of the first Bluetooth device and the second identification code of the second Bluetooth device;
wherein the control device transmits the control command to the first Bluetooth device or the second Bluetooth device according to the first identification code or the second identification code, such that the first Bluetooth device or the second Bluetooth executes the action corresponding to the control command.

6. The Cloud Bluetooth device management system of claim 4, wherein the identification code is a media access control address code of each Bluetooth device.

7. The Cloud Bluetooth device management system of claim 5, wherein the identification codes of the Bluetooth devices are stored in a Bluetooth device management database of the server.

8. The Bluetooth device management of claim 5, further comprising:
a second gateway device communicating with a third Bluetooth device and a fourth Bluetooth device, the third Bluetooth device including a third identification code and the fourth Bluetooth device including a fourth identification code;
wherein the third Bluetooth device transmits a first control command and the first identification code to the server through the second gateway device according to the Bluetooth device management database, the server compares the first identification code with the identification codes stored in the Bluetooth device management database for determining whether the target device is the first Bluetooth device according to the first control command and the first identification code transmitted by the third Bluetooth device, when the target device is determined, the server transmits the first control command to the first Bluetooth device corresponding to the first identification code.

9. The Cloud Bluetooth device management system of claim 5, wherein the first Bluetooth device and the second Bluetooth device are connected to the first gateway device by a first communication protocol.

10. The Cloud Bluetooth device management system of claim 9, wherein the first communication protocol includes a WiFi protocol, a LoRa protocol, a Sigfox protocol, a 4G protocol, or a 5G protocol.

11. The Cloud Bluetooth device management system of claim 9, wherein the first gateway device is connected to the server by a second communication protocol, the second communication protocol includes a WiFi protocol, a LoRa protocol, a Sigfox protocol, a 4G protocol, or a 5G protocol.
